(19) United States
(12) Patent Application Publication
(10) Pub. No.: US 2010/0123086 A1
(43) Pub. Date: May 20, 2010

(54) EXTREME ULTRAVIOLET LIGHT SOURCE DEVICE

(75) Inventor: Daiki YAMATANI, Gotenba-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIODENKI KABUSHIKI KAISHA, Tokyo (JP)

(21) Appl. No.: 12/613,716

(22) Filed: Nov. 6, 2009

(30) Foreign Application Priority Data
Nov. 19, 2008 (JP) 2008-295285

(51) Int. Cl. G21K 5/00; G01J 1/42

(52) U.S. Cl. 250/393; 250/504 R

(57) ABSTRACT

An extreme ultraviolet (EUV) light source to detect fluctuations in the angular distribution of its output radiation wherein a solid raw material is irradiated with a laser beam to generate a vapor. The vapor is subjected to an electrical arc generated between a pair of discharge electrodes to generate a high temperature plasma that emits EUV radiation. The EUV radiation is collected along an optical axis toward a focal point by a plurality of concentrically arranged reflectors. A plurality of EUV radiation detectors are arranged around a circular ring centering on the optical axis of the concentrically arranged reflectors. Each EUV radiation detector includes two spaced apart diaphragms with a pinhole. The pinholes are aligned with a virtual line connecting with the focal point. EUV radiation passing through the pinholes strikes a light detecting element in the detectors. The angular distribution fluctuation of the EUV radiation collected at the focal point is obtained based upon irradiance data provided by the light detectors.

### BACKGROUND OF THE INVENTION

1. Field of Invention

The present invention generally relates to a light source device for emitting extreme ultraviolet radiation having a wavelength of about 13.5 nm (hereafter referred to as EUV radiation), and is particularly concerned with an EUV light source having the ability to detect fluctuations in the angular distribution of its emitted radiation.

2. Description of Related Art

With progressing miniaturization and high integration of semiconductor integrated circuits, there are demands for improved resolution in projection lithography devices for manufacturing semiconductor integrated circuits. In order to improve the resolution, it is common to use exposure light sources emitting radiation with short wavelengths.

### SUMMARY OF THE INVENTION

An excimer laser device is used as an exposure light source emitting radiation with a short wavelength, and as a next generation exposure light source, as an alternative of the excimer laser device, development of extreme ultraviolet light source devices emitting extreme ultraviolet radiation particularly with a wavelength of 13.5 nm is in progress.

EUV radiation may be generated from a high temperature plasma by heating and exciting discharge gas containing an extreme ultraviolet radiation species, and extracting the extreme ultraviolet radiation emitted from this plasma. The extreme ultraviolet light source devices where such methods are adopted are roughly classified as a laser produced plasma (LPP) system and a discharge produced plasma (DPP) system according to the type of generating the high temperature plasma.

In an LPP-type EUV light source system, a laser beam is directed on a target made from a raw material containing an extreme ultraviolet radiation species to produce high temperature plasma by laser sputtering. EUV light is emitted from the plasma.

In the DPP-type EUV light source system, a high temperature plasma is formed by discharging high voltage between electrodes to which discharge gas containing an extreme ultraviolet radiation species is supplied. Again, EUV radiation is emitted from the plasma. In such a DPP-type EUV light source system, since the light source device can be miniaturized and there is a practical advantage in that power consumption of the light source system is small compared to the LPP-type EUV light source system.

Xe (xenon) ions with a valence of about 10 are known as a raw material to generate the high temperature plasma. Li (lithium) ions and Sn (tin) ions may also be used as raw materials for emitting a stronger extreme ultraviolet radiation.

The EUV conversion efficiency of Sn is several fold greater than that of Xe. Therefore, Sn is preferably used for generating EUV radiation with high intensity. The conversion efficiency is defined as the ratio of the electrical input for generating the high temperature plasma to the radiation intensity of the EUV radiation having a wavelength of 13.5 nm. For example, as described in JP-A-2004-279246 and corresponding US 2004/0183038 A1, development of an EUV light source device using SnH₄ (stannane) gas as an extreme ultraviolet radiation species is in progress.

Recently, “Present Status and Future of EUV (Extreme Ultra Violet) Light Source Research, J. Plasma Fusion Res., Vol. 79, No. 3, (2003), P219-260, has disclosed in a DPP-type system, a method of first vaporizing solid or liquid Sn or Li supplied onto the electrode surface where discharge is generated by emitting an energy beam, such as a laser beam, to the resulting ions, and then generating high temperature plasma by an electrical discharge.

FIG. 7 is a diagram for simply explaining a EUV light source device shown in JP-A-2004-279246 and corresponding US 2004/0183038 A1.

The EUV light source device is composed of a discharge vessel 1a where a pair of disk-like discharge electrodes 2a, 2b are housed, and an EUV collector 1b where a foil trap 5 and a collecting mirror reflector 6 are housed. The pair of disk-like discharge electrodes 2a, 2b is arranged in the discharge vessel 1a, vertically on the paper plane of FIG. 7.

A shaft having an axis of rotation 2e of a motor 2d is mounted in the discharge electrode 2b positioned at a lower side of the figure. The discharge electrodes 2a, 2b are connected to a pulsed power supply part 3 via wipers 2g, 2h, respectively.

A groove 2i is provided around the periphery of the discharge electrode 2b, and a solid raw material M (Li or Sn) for generating the high temperature plasma is arranged in this groove 2i. In the EUV light source device, a laser beam from a laser beam irradiator 4 is directed onto the raw material arranged in the groove 2i of the discharge electrode 2b via a laser entrance window 4a, and the solid material is vaporized between the discharge electrodes 2a, 2b.

Under such conditions, pulsed power is supplied from the pulsed power supply 3 between the discharge electrodes 2a, 2b, and a discharge is generated between an edge part of the discharge electrode 2a and an edge part of the discharge electrode 2b, and EUV radiation is emitted. The emitted EUV radiation enters into the EUV collector 1b via the foil trap 5, and the EUV radiation is focused at the focal point P of the EUV light source device by the collecting mirror reflector 6, and is emitted from a EUV radiation output window 7.

An aperture member 8 for narrowing down the EUV radiation within a predetermined range is placed at the end of the EUV radiation output window 7. The aperture member 8 is donut-like having an opening in the center, and is arranged so as to position the opening at the focal point P.

However, in such an EUV light source device, there are practical problems to be explained below.

In particular, when the EUV source device is lit and operated for a long period of time, there is a problem that the angular distribution characteristic beyond the focal point P deteriorates and the angular distribution characteristic around the optical axis becomes asymmetric. For example the following three are considered as causes deteriorating the angular distribution characteristic and causing the asymmetry:

(1) The position of the plasma formed between the pair of discharge electrodes fluctuates by wear of the discharge electrodes along with the passage of lighting and driving time compared to the irradiance initial state.

(2) The foil trap becomes heated to a high temperature due to heat generated by the discharge electrodes, which causes thermal strain and deformation.

(3) Strain occurs to the collecting mirror reflector.

As described above, when the angular distribution characteristic beyond the focal point P is deteriorated and becomes asymmetric, exposure unevenness may occur on an article to be treated.

However, in a conventional EUV light source device, such deterioration of the angular distribution characteristic of the extreme ultraviolet radiation beyond the focal point P and asymmetry are not detected. Consequently, even if the angular distribution characteristic of the extreme ultraviolet radiation has deteriorated beyond the focal point P due to movement of the plasma position caused by wear of the discharge electrodes, thermal strain of the foil trap or strain of the collecting mirror reflector, this cannot be grasped, and exposure unevenness may occur to an article to be treated.

### SUMMARY OF THE INVENTION

The object of the present invention is to enable the detection of a deterioration in the symmetry of the angular distribution characteristic of the EUV radiation beyond the focal point of the EUV light source device.

In the EUV light source device of the present invention, the plasma formed between the pair of discharge electrodes is spatial. Consequently, the EUV radiation emitted from the plasma is not all collected at the focal point of the EUV light source device, such that some light will never be led into the exposure device. Therefore, it is meaningless to detect the fluctuation of the angular distribution of the EUV radiation that is not collected at the focal point and led into the exposure device.

Accordingly, in the present invention, the EUV radiation that is not collected at the focal point is eliminated from consideration, and a detecting means for accurately detecting only the angular distribution fluctuation of the EUV radiation that is collected at the focal point is provided, such that only the angular distribution fluctuation of the EUV radiation that is collected at the focal point is detected.

In other words, in the present invention, the problem is solved as follows:

(1) A detecting means for detecting irradiance fluctuations of only the extreme ultraviolet radiation reflected by the collecting mirror reflector is provided, the detecting means comprising a diaphragm member having a pinhole, such that EUV radiation that is not collected at the focal point is eliminated from consideration.

(2) In (1), the detecting means comprises a plurality of diaphragms axially arranged and spaced from each other.

(3) In (2), in each of the diaphragm members, the pinholes are arranged to be aligned on a virtual line connecting the focal point where the extreme ultraviolet radiation to be emitted from the collecting mirror reflector is collected with any point on a reflecting surface of the collecting minor reflector.

(4) In (1), (2) and (3), a plurality of detecting means are provided, and the detecting means are arranged on a circular ring centering on the optical axis of the collecting minor reflector.

(5) In (4), the detecting means comprises a reflecting mirror for reflecting extreme ultraviolet radiation passing through the diaphragm member toward a direction away from the optical axis of the collecting mirror reflector, respectively.

(6) In (5), the reflecting minor has a reflecting surface for reflecting extreme ultraviolet radiation with a wavelength of 13.5 nm.

(7) In (6), the reflecting surface of the reflecting minor is made of Mo (molybdenum) and Si (silicon).

(8) In (1) to (7), the collecting mirror reflector comprises a plurality of reflecting surfaces nested inside one another without making contact with each other, and the diaphragm members of the detecting means are arranged along a traveling direction of the extreme ultraviolet radiation to be reflected by the reflecting mirror arranged the furthest from the optical axis of the collecting mirror reflector.

(9) The extreme ultraviolet light source device in (1) to (7) comprises a raw material for emitting the extreme ultraviolet radiation; an energy beam emitting means for emitting an energy beam onto a surface of the raw material for the purpose of vaporizing the raw material; a pair of discharge electrodes for heating and exciting the vaporized raw material within the discharge vessel by discharge for the purpose of generating plasma; a pulsed power supply means for supplying pulsed power to the discharge electrodes; and an aperture member that has an opening for narrowing down the extreme ultraviolet radiation emitted from the plasma to a predetermined size, this opening being aligned with a focal point where the extreme ultraviolet radiation reflected by the collecting mirror reflector is collected.

### EFFECT OF THE INVENTION

In the present invention, the following effects can be obtained:

(1) Since the detecting means for the extreme ultraviolet radiation comprises at least one diaphragm member having a pinhole for the purpose of narrowing down the extreme ultraviolet radiation, even if the angular distribution characteristic of the extreme ultraviolet radiation fluctuates due to various factors, such as wear of the discharge electrodes, thermal strain of the foil trap, or strain of the collecting mirror reflector, the degree of fluctuation of the angular distribution characteristic of the extreme ultraviolet radiation reflected by the mirror reflector can be detected with high accuracy.

(2) Placement of a plurality of diaphragm members arranged isolated and spaced from each other in the detecting means enables the detection of the degree of fluctuation of the angular distribution characteristic of the extreme ultraviolet radiation with high accuracy.

Further, an arrangement of the diaphragm members on a virtual line connecting the focal point for collecting the extreme ultraviolet radiation reflected by the collecting mirror reflector with any point on a reflecting surface of the collecting mirror reflector enables elimination of EUV radiation that is not collected at the focal point and the detection of only radiation that is collected at the focal point, and the fluctuation of the angular distribution characteristic of the EUV radiation that is collected at the focal point can be effectively detected without interference from EUV radiation that is not collected at the focal point.

### BRIEF DESCRIPTION OF THE DRAWINGS

FIG. 1 is a cross-sectional schematic view of an EUV light source device in an embodiment of the present invention.

FIG. 2 is a front view along the optical axis of the EUV light source device in the embodiment of the present invention from the collecting mirror reflector side.

FIG. 3 is a partial explanatory side view of the detection means for detecting extreme ultraviolet radiation in the embodiment of the present invention.

FIG. 4 illustrates the EUV light source device in a comparative example having a detection means not including a diaphragm having a pinhole.

FIG. 5 shows an example of the EUV light source device of the present invention comprising a detection means including two diaphragm members with aligned pinholes.

FIG. 6 shows another example of the EUV light source device of the present invention.

FIG. 7 briefly explains a configuration example of a prior art EUV light source device.

### DETAILED DESCRIPTION OF THE INVENTION

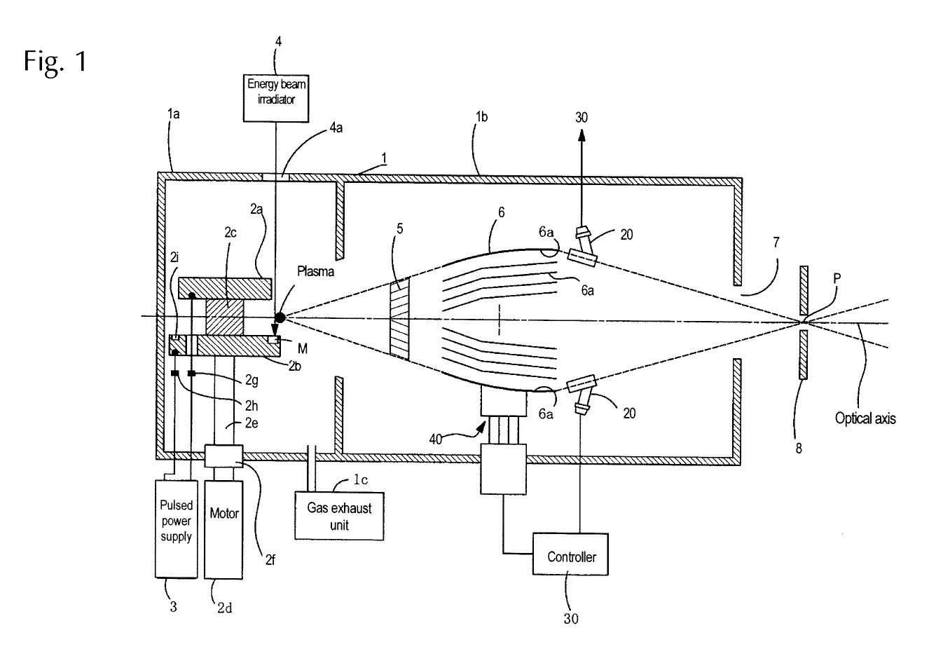

FIG. 1 is a side schematic representation of the EUV light source device of an embodiment of the present invention.

The EUV light source device is equipped with a chamber 1 comprising a discharge vessel 1a where discharge electrodes are housed, and an EUV collector 1b where a foil trap 5 and a collecting mirror reflector 6 are housed, similar to that shown in FIG. 7.

The chamber 1 contains the discharge vessel 1a and a gas exhaust unit 1c for exhausting air from the EUV collector 1b and producing a vacuum in the chamber 1.

A pair of disk-like discharge electrodes 2a, 2b are arranged facing each other across an insulating member 2c.

A motor 2d having an output shaft that rotates about an axis of rotation 2e and is mounted in the discharge electrode 2b is positioned at the lower side of the chamber 1. The center of the discharge electrode 2a and the discharge electrode 2b are positioned coaxially with respect to the axis of rotation 2e. The axis of rotation 2e is introduced into the chamber 1 via a mechanical seal 2f. The mechanical seal 2f allows for rotation of the axis of rotation 2e while the reduced-pressure atmosphere within the chamber 1 is maintained.

Wipers 2g, 2h made of, for example, carbon brush, are placed at the lower side of the discharge electrode 2b. The wiper 2g is electrically connected with the discharge electrode 2a via a through-hole placed in the discharge electrode 2b. The wiper 2h is electrically connected to the discharge electrode 2b.

The peripheral parts of the disk-like discharge electrodes 2a, 2b are formed as annular edges. Further, a liquid or solid raw material M for high temperature plasma production is arranged in a groove 2i disposed around the annular edge of discharge electrode 2b. The raw material M is, for example, tin (Sn) or lithium (Li).

When power is supplied to the discharge electrodes 2a, 2b by a pulsed power supply 3, a discharge is generated between the annular edges of both electrodes.

When the discharge is generated, the annular edges of discharge electrodes 2a, 2b are raised to a high temperature. Consequently, the discharge electrodes 2a, 2b are made from high melting-point metal, such as tungsten, molybdenum or tantalum. The insulating member 2c is made from silicon nitride, aluminum nitride or diamond for the purpose of providing insulation between the discharge electrodes 2a, 2b.

An energy beam irradiator 4 for the purpose of irradiating the raw material M with an energy beam and vaporizing the raw material M communicates with (or may be placed in) the chamber 1. The energy beam emitted from the energy beam irradiator 4 is, for example, a laser beam.

The laser beam generated by the energy beam irradiator 4 is focused on the raw material M arranged in the groove 2i of the discharge electrode 2b via the laser entrance window 4a. With this irradiation, the solid raw material M is vaporized between the discharge electrodes 2a, 2b to generate high temperature plasma.

The foil trap 5 arranged in the EUV collector 1b is placed for preventing debris produced by the raw material M during the generation of high temperature plasma from scattering toward the collecting mirror reflector 6. In the foil trap 5, a plurality of narrow voids defined by a plurality of concentrically arranged, radially-extending thin plates are formed.

In the collecting mirror reflector 6 arranged in the EUV collector 1b, light-reflecting surfaces 6a for reflecting the EUV radiation with a wavelength of 13.5 nm emitted by the high temperature plasma are formed.

The collecting mirror reflector 6 is composed of the plurality of light-reflecting surfaces 6a, which are nested inside one another, without making contact with each other. Each light-reflecting surface 6a is formed to excellently reflect extreme ultraviolet radiation with an incidence angle of 0 to 25° by coating the reflecting surface side of a basis material having a smooth surface made of Ni (nickel) with metal, such as Ru (ruthenium), Mo (molybdenum) or Rh (rhodium). Each light-reflecting surface 6a is formed so as to focus the EUV radiation emitted from the high temperature plasma onto the focal point P.

An EUV radiation output window 7 is placed in the light output direction of the collecting mirror reflector 6. The EUV radiation output window 7 is formed by an opening formed in the EUV collector 1b.

An aperture member 8 is arranged outside the chamber 1 at the end of the EUV radiation output window 7. The aperture member 8 is formed to be donut-shaped having an opening in the center which is arranged at the focal point P of the EUV light source device. The focal point P of the EUV light source device is matched with the focal point P where the EUV radiation emitted from the collecting mirror reflector 6 is collected.

A plurality of detecting means 20 of the EUV light source device of the present invention are placed for the purpose of detecting the angular distribution fluctuation of the EUV radiation entering the focal point P. This is for the purpose of preventing the generation of irradiation unevenness in an article to be treated by the lithography tool by detecting the angular distribution fluctuation of the irradiance of EUV radiation beyond the focal point P as the light passes through the focal point P and enters into the lithography tool.

Herein, in the EUV light source device, as shown in FIG. 1, since the plasma formed between the pair of the discharge electrodes 2a, 2b is spatial, the EUV radiation emitted from the plasma is not all collected at the focal point P. Rather, the radiation collected at the focal point P is only part of the EUV radiation emitted from the plasma.

Therefore, in order to detect the angular distribution fluctuation of the EUV radiation collected at the focal point P, it is necessary to detect only the EUV radiation collected at the focal point P by eliminating EUV radiation that is not collected at the focal point P out of the radiation emitted by the plasma. The detecting means 20 for this purpose is explained hereafter. As will be explained in detail hereinafter, the detecting means 20 is structured so as to detect only EUV radiation reflected by the mirror reflector 6.

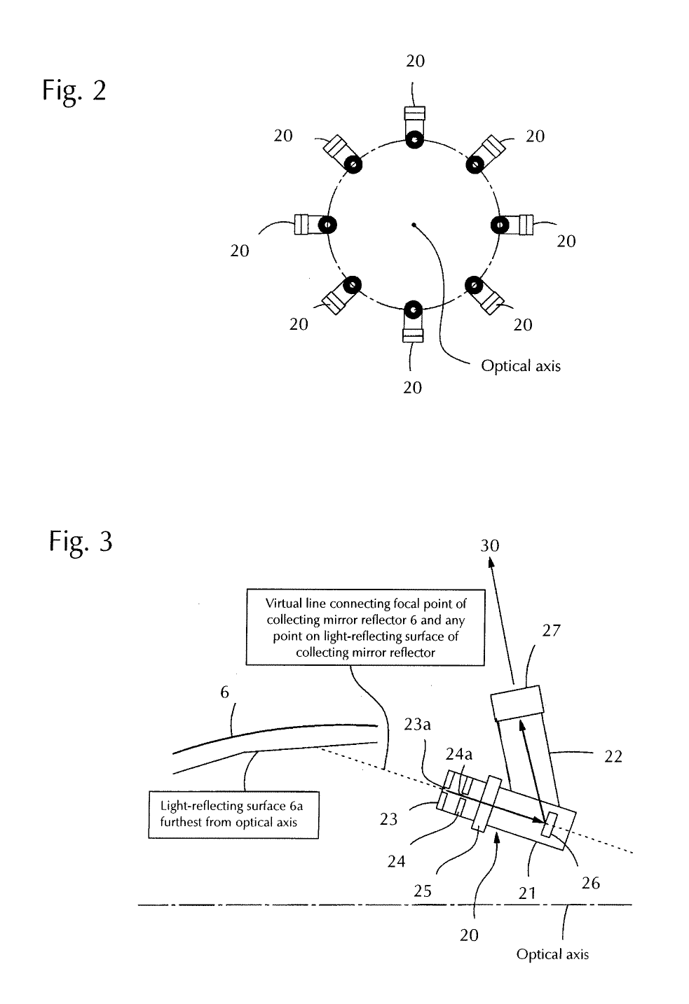

FIG. 2 is a front view of the EUV light source device viewed from the collecting mirror reflector side. As shown in FIG. 2, the EUV light source device comprises a plurality of detecting means 20 for detecting the irradiance of the EUV radiation. The plurality of detecting means 20 (eight in FIG. 2) are arranged on the circular ring centering on the optical axis of the collecting mirror reflector 6 at equal intervals from each other. Each detecting means 20, as shown in FIG. 1, is arranged between the focal point P (focal point of the collecting mirror reflector 6) of the EUV light source device and the end of the light-reflecting surface 6a of the collecting mirror reflector 6.

FIG. 3 is a partial explanatory view showing the detecting means for detecting extreme ultraviolet radiation. As shown in FIG. 3, the detecting means 20 is integrally formed with a cylindrical body tube 21 extending in parallel to the traveling direction of the EUV radiation on the side of the body tube 21, and has a branch pipe 22 extending toward the direction away from the optical axis of the collecting mirror reflector 6. The body tube 21 and the branch tube 22 communicate via an internal space, respectively.

The body tube 21 of the detecting means 20 is arranged in the traveling direction of the EUV radiation emitted from the light-reflecting surface 6a arranged the furthest from the optical axis in the collecting mirror reflector 6. The branch pipe 22 of the detecting means 20 is not arranged in the traveling direction of the EUV radiation reflected by the light-reflecting surface 6a of the collecting mirror reflector 6.

Two diaphragm members 23, 24 having a pinhole, respectively, a wavelength selecting element 25 and a reflecting mirror 26 are arranged in respective order within the body tube 21 in the traveling direction of the EUV radiation reflected by the collecting mirror reflector 6. The two diaphragm members 23, 24 are arranged isolated from each other in the traveling direction of the EUV radiation reflected by the collecting mirror reflector 6.

The purpose of providing the diaphragm members 23, 24 is to eliminate EUV radiation that does not enter into the focal point P and to detect only radiation that has been collected at the focal point P. Stated differently, only radiation reflected by the light reflecting surface 6a along the virtual line in FIG. 3 enters both of the pinholes 23a and 24a in the diaphragm members 23, 24. The pinholes 23a and 24a of the diaphragm members 23, 24 are extremely minute, respectively, and eliminate light that does not pass through the pinholes by absorption or reflection.

The diaphragm members 23, 24 are arranged so as to align on a virtual line connecting the focal point P of the EUV light source device (focal point of the collecting mirror reflector) with any point on the light-reflecting surface 6a of the collecting mirror reflector 6.

The number of the diaphragms 23, 24 is not particularly restricted as long as the radiation that does not enter into the focal point P of the EUV light source device can be eliminated. The number of the diaphragms 23, 24 is preferably many according to the reason described below. However, even if the number of the diaphragm members 23, 24 is small, the EUV radiation that does not enter into the focal point P can be eliminated by reducing the diameter of the pinholes 23a and 24a or expanding the distance between the diaphragm members by spacing them apart.

A wavelength selecting element 25 lets only the EUV radiation with a wavelength of 5 to 20 nm pass out of the radiation reflected by the collecting mirror reflector 6, and eliminates radiation with other wavelengths by absorption or reflection. Entrance of radiation with other wavelengths into the reflecting mirror 26 can be reduced by placing the wavelength selecting element 25 at the front side of the diaphragm members 23, 24.

The light-reflecting surface of the reflecting mirror 26 is arranged so as to reflect the EUV radiation with a wavelength of 13.5 nm±4% reflected by the collecting mirror reflector 6 toward the direction away from the optical axis of the collecting mirror reflector 6. The light-reflecting surface of the reflecting mirror 26 is to mainly reflect the EUV radiation with a wavelength of 13.5 nm toward the direction of the branch pipe 22, and for example, is made of Mo (molybdenum) and Si (silicon).

The EUV radiation that passes through the pinholes 23a and 24a of the diaphragm members 23, 24 and, concurrently, that is reflected by the reflecting mirror 26 is reflected toward the direction of the branch pipe 22 and enters into a reception surface of a light receiving element 27 secured at the end of the branch tube 22.

The light receiving element 27 is, for example, formed from photodiodes. The light receiving element 27 sends irradiance data relating to the received EUV radiation as an electric signal to a control means 30 (see FIG. 1).

The control means 30 obtains the angular distribution fluctuation of the EUV radiation collected at the focal point P of the EUV light source device by predetermined arithmetic processing based upon the irradiance data received from the light receiving element 27.

The control means 30 sends position correction data for correcting the position of the collecting mirror reflector 6 to a collecting mirror reflector drive mechanism 40 based upon the angular distribution fluctuation of the EUV radiation obtained as described above. The collecting mirror reflector drive mechanism 40 drives the collecting mirror reflector 6 based upon the position correction data and corrects the angular distribution fluctuation of the EUV radiation at the focal point P.

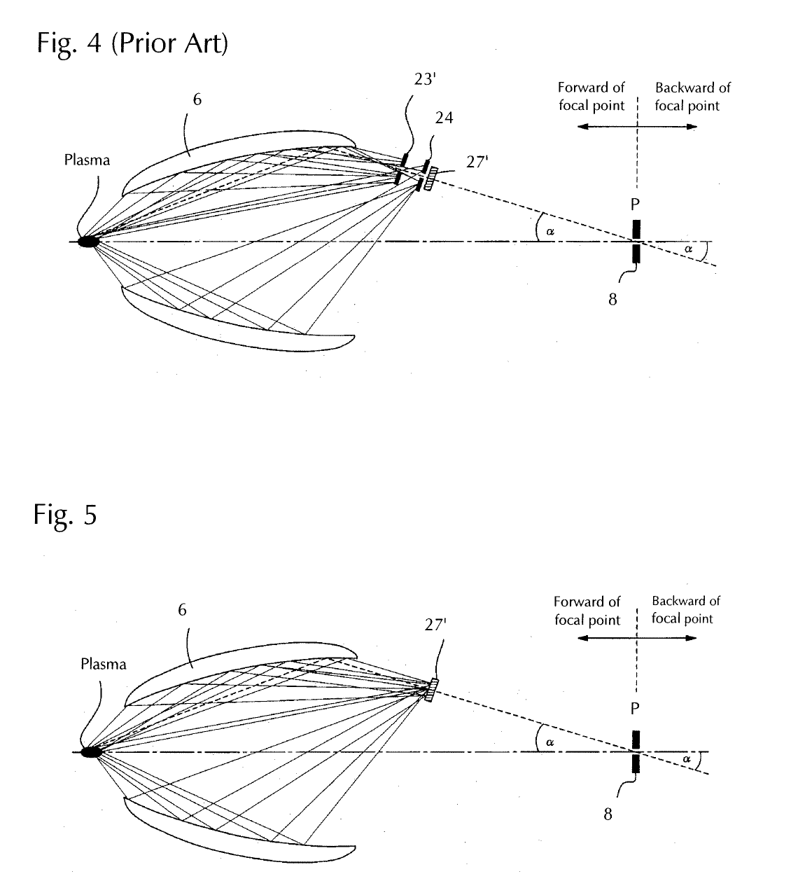

In the EUV light source device of the present invention since the detecting means 20 for detecting the irradiance of the EUV radiation has at least one diaphragm member having a pinhole, the specific effects mentioned below can be expected. Hereafter, the effects are explained with reference to FIG. 4 and FIG. 5.

FIG. 4 shows an EUV light source device in a comparative example not comprising any diaphragm member having a pinhole. FIG. 5 shows one example of the EUV light source device of the present invention comprising two diaphragm members having a pinhole. Furthermore, FIG. 5, for convenience, shows only the diaphragm members 23′ and 24′ and the light receiving element 27′ in the detecting means 20 shown in FIG. 3.

In the EUV light source devices in FIGS. 4 & 5, the light receiving element 27′ for detecting the EUV radiation with a wavelength of 13.5 nm is arranged between the collecting mirror reflector and the focal point P.

According to the EUV light source device in the comparative example, as shown in FIG. 4, all EUV radiation emitted from the plasma formed between a pair of the discharge electrodes enters into the reception surface of the light receiving element 27′. Consequently, radiation collected at the focal point P (radiation entered into the focal point at the angle α) enters into the reception surface of the light receiving element 27′ along with radiation that is not collected at the focal point P. Therefore, according to the EUV light source device in the comparative example, the angular distribution fluctuation of the irradiance of the radiation collected at the focal point P cannot be accurately detected.

On the other hand, according to the example of the EUV light source device of the present invention shown in FIG. 5, two diaphragm members 23′, 24′ separated from each other are placed in front of the light receiving element 27′. Therefore, out of the EUV radiation emitted from the plasma, the EUV radiation that does not enter into the focal point P is eliminated by the diaphragm members 23′, 24′, and only the EUV radiation that is collected at the focal point P (radiation entered into the focal point at the angle α) enters into the reception surface of the light receiving element 27′. Therefore, according to the example of the EUV light source device of the present invention, the angular distribution fluctuation of the irradiance of the radiation collected at the focal point P can be accurately detected.

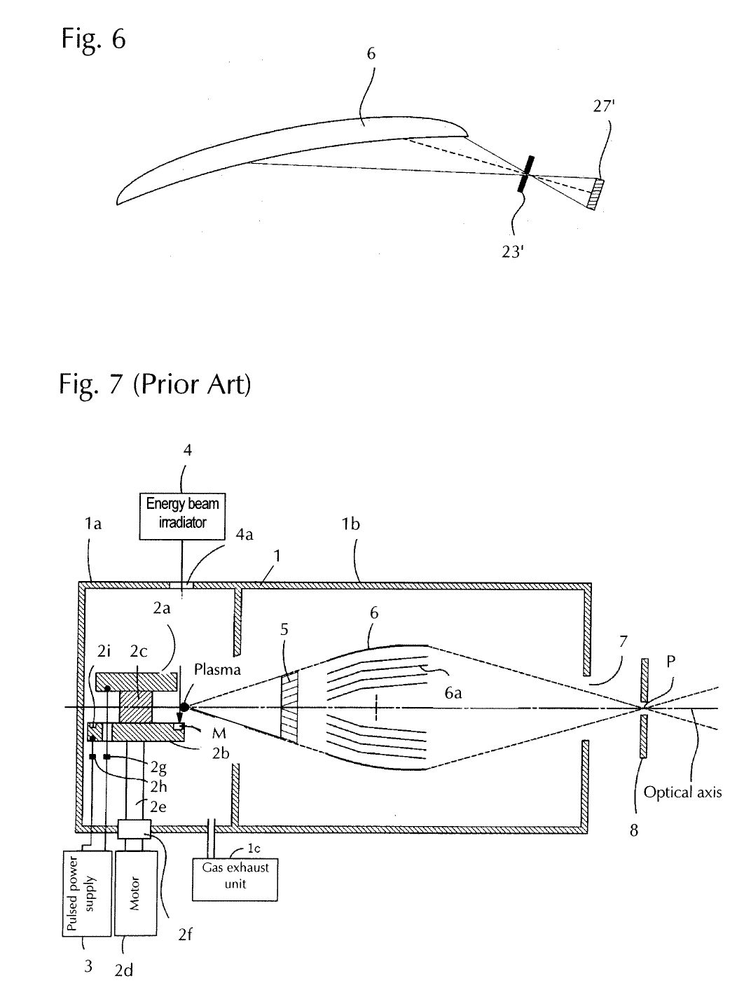

Furthermore, FIG. 6 shows another example of the EUV light source device of the present invention. One diaphragm member 23′ is placed in front of the light receiving element 27′ in the EUV light source device shown in FIG. 6. In other words, according to the EUV light source device shown in FIG. 6, a majority of the EUV radiation that is not collected at the focal point P can be eliminated. Therefore, the EUV light source device shown in FIG. 6 can accurately detect the angular distribution fluctuation of the EUV radiation collected at the focal point P compared to the EUV light source device shown in FIG. 4, though not to the extent of the EUV light source device shown in FIG. 5.

What is claimed is:

1. An extreme ultraviolet light source device, comprising:
a collecting mirror reflector for collecting extreme ultraviolet radiation; and
a detecting means for detecting irradiance of the extreme ultraviolet radiation reflected by the collecting mirror reflector, wherein
the detecting means comprises a diaphragm member having a pinhole for admitting only extreme ultraviolet radiation reflected by the collecting mirror reflector.

2. The extreme ultraviolet light source device according to claim 1, wherein the detecting means comprises a plurality of diaphragms spaced apart along an axis.

3. The extreme ultraviolet light source device according to claim 2, wherein, in each of the diaphragm members, the pinholes are arranged to be aligned on a virtual line connecting a focal point where the extreme ultraviolet radiation reflected by the collecting mirror reflector is collected with any point on a reflecting surface of the collecting mirror reflector.

4. The extreme ultraviolet light source device according to claim 1, wherein a plurality of detecting means are provided; and wherein the detecting means are arranged around a circular ring centered on an optical axis of the collecting mirror reflector.

5. The extreme ultraviolet light source device according to claim 4, wherein the detecting means comprise a reflecting mirror for reflecting extreme ultraviolet radiation passing through the diaphragm member toward a direction away from the optical axis of the collecting mirror reflector, respectively.

6. The extreme ultraviolet light source device according to claim 5, wherein the reflecting mirror has a reflecting surface for reflecting extreme ultraviolet radiation with a wavelength of 13.5 nm.

7. The extreme ultraviolet light source device according to claim 6, wherein the reflecting surface of the reflecting mirror is formed with Mo and Si.

8. The extreme ultraviolet light source device according to claim 1, wherein the collecting mirror reflector comprises a plurality of reflecting surfaces nested inside one another without making contact with each other; and wherein the diaphragm member of the detecting means intersects with a traveling direction of the extreme ultraviolet radiation reflected by the reflecting mirror arranged furthest from the optical axis of the collecting mirror reflector.

9. The extreme ultraviolet light source device according to claim 1, comprising:
a raw material for emitting the extreme ultraviolet radiation;
an energy beam radiating means for radiating an energy beam onto a surface of the raw material for the purpose of vaporizing the raw material;
a pair of discharge electrodes for heating and exciting the vaporized raw material by discharge for the purpose of generating plasma;
a pulsed power supply means for supplying pulsed power to the discharge electrodes; and
an aperture member that has an opening for narrowing down the extreme ultraviolet radiation emitted from the plasma to a predetermined size, and where the opening is arranged at a focal point where the extreme ultraviolet radiation reflected by the collecting mirror reflector is collected.
